(19) United States
(12) Patent Application Publication
(10) Pub. No.: US 2009/0095203 A1
(43) Pub. Date: Apr. 16, 2009

(54) METHOD FOR REDUCING CURLING AND/OR WARPING IN POURED CONCRETE AND STRUCTURE MADE THEREBY

(75) Inventor: John W. ROBERTS, Richmond, VA (US)

Correspondence Address: MCGUIREWOODS, LLP, 1750 TYSONS BLVD, SUITE 1800, MCLEAN, VA, 22102, US

(73) Assignee: Northeast Solite Corporation, Richmond, VA (US)

(21) Appl. No.: 12/251,168

(22) Filed: Oct. 14, 2008

Related U.S. Application Data
(60) Provisional application No. 60/979,651, filed on Oct. 12, 2007.

(51) Int. Cl. C04B 28/06; B28B 1/14

(52) U.S. Cl. 106/694; 106/695; 264/299

(57) ABSTRACT

The invention discloses a method for reducing curling, warping, or both in poured concrete. The method includes substituting a lightweight fine aggregate for at least a portion of the natural fine aggregate in a concrete mixture, mixing the components, pouring the mixture, and curing the poured concrete. The invention also discloses a concrete component, formed by the method, for use in building a parking structure.

### CROSS-REFERENCE TO RELATED APPLICATIONS

This application claims priority under 35 U.S.C. §119(e) to provisional U.S. Patent Application No. 60/979,651, filed on Oct. 12, 2007, the disclosure of which is expressly incorporated by reference herein in its entirety.

### BACKGROUND OF THE INVENTION

1. Field of the Invention

The disclosure is directed generally to a method and composition that reduces curling and/or warping in poured concrete and, more particularly, to poured concrete slabs for use in construction. Moreover, the disclosure is directed to a method and composition for reducing curling and/or warping in concrete slabs utilized in building parking structures or concrete highways, roadways, pavements, and parking areas on the ground.

2. Related Art

Warping in concrete typically occurs when there is a differential in internal moisture content between different sides or faces of a concrete slab. Curling typically occurs when there is a temperature differential between different sides or faces of a concrete slab. Concrete pavements, including highways, roads, streets, parking lots, driveways, and the like, are particularly susceptible to warping and/or curling because they undergo moisture and temperature differentials between their top and bottom surfaces. Parking structures constructed from concrete slabs are also sensitive to defects such as warping and/or curling in the concrete slabs, and the Parking Structure Committee (362) of the American Concrete Institute has considered guidelines restricting the amount of warping acceptable in such slabs.

Currently, concrete parking structures are built using concrete with one of the following compositions: (1) natural coarse aggregates and natural fine aggregates; (2) lightweight coarse aggregates and natural fine aggregates; or (3) lightweight coarse aggregates and lightweight fine aggregates. Only the second two of these compositions, i.e. (2) and (3) above, have been to shown to possess a particular resistance to warping and/or curling. However, almost all parking structures use natural coarse aggregates and natural fine aggregates, i.e. (1) above due to the cost of this combination.

Accordingly, there is a need for a method and composition that can be used to reduce the curling and/or warping of concrete slabs and/or concrete pavements using natural coarse aggregates and natural fine aggregate combinations.

### SUMMARY OF THE INVENTION

The disclosure meets the foregoing need and provides a method and composition that is resistant to warping and/or curling and that furthermore includes other advantages apparent from the discussion herein.

Accordingly, in one aspect of the invention, a method for reducing warping and/or curling in poured concrete includes substituting a lightweight fine aggregate for at least a portion of the natural fine aggregate in a concrete mixture, mixing the components, pouring the mixture, and curing the poured concrete.

The lightweight fine aggregate may substitute for 5% of the natural fine aggregate in the mixture. The lightweight fine aggregate may substitute for 10% of the natural fine aggregate. The lightweight fine aggregate may substitute for 20% of the natural fine aggregate. The lightweight fine aggregate may substitute for 40% of the natural fine aggregate. The lightweight fine aggregate may substitute for 80% of the natural fine aggregate. The lightweight fine aggregate may substitute for 100% of the natural fine aggregate. The poured concrete may include a hydrating fluid. The lightweight fine aggregate may be synthetic aggregate, expanded clay, expanded shale, or expanded slate. The lightweight fine aggregate may include alumna, greater than 50% silica, less than 10% iron oxide, less than 2% calcium oxide, less than 5% magnesium oxide, less than 5% calcium carbonate, and less than 10% magnesium carbonate. Furthermore, the alumna may be less than 20% of the lightweight fine aggregate, or the alumna may be greater than 20% of the lightweight fine aggregate. The natural coarse aggregate may be sand, gravel, or stone. The method may produce a component for constructing at least one of a pavement, a parking structure, a roadway, a highway, a parking lot, a bridge, and a building. In addition, the method may produce a slab for at least one of a pavement, a house, a parking lot, a roadway, a highway, a bridge, and a building. The poured concrete may include a concrete admixture.

According to another aspect of the invention, a concrete component for building a parking structure includes a lightweight fine aggregate and a natural coarse aggregate. The lightweight fine aggregate and the natural coarse aggregate are combined in proportions to reduce warping, curling, or both.

The lightweight fine aggregate may substitute for 5% of the natural fine aggregate in the component. The lightweight fine aggregate may substitute for 10% of the natural fine aggregate. The lightweight fine aggregate may substitute for 20% of the natural fine aggregate. The lightweight fine aggregate may substitute for 40% of the natural fine aggregate. The lightweight fine aggregate may substitute for 80% of the natural fine aggregate. The lightweight fine aggregate may substitute for 100% of the natural fine aggregate. The component may include a hydrating fluid. The lightweight fine aggregate may be synthetic aggregate, expanded clay, expanded shale, or expanded slate. The lightweight fine aggregate may include alumna, greater than 50% silica, less than 10% iron oxide, less than 2% calcium oxide, less than 5% magnesium oxide, less than 5% calcium carbonate, and less than 10% magnesium carbonate. Furthermore, the alumna may be less than 20% of the lightweight fine aggregate, or the alumna may be greater than 20% of the lightweight fine aggregate. The natural coarse aggregate may be sand, gravel, or stone.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a flowchart of a method of the disclosure.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

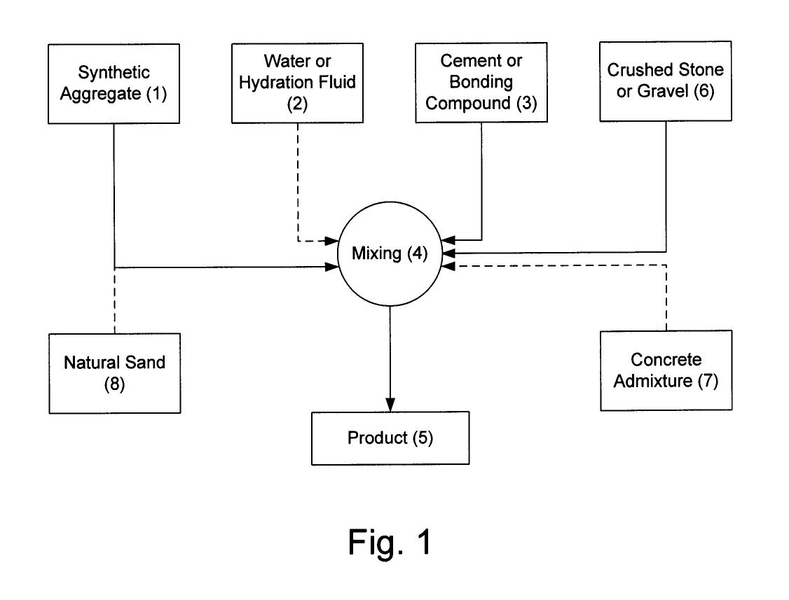

With reference to FIG. 1, the disclosure may be practiced by, for example, combining a synthetic aggregate, expanded clay, expanded shale, expanded slate, or the like (1) with a cement or other bonding compound (3) in a mixture concentration as appropriate depending on the particular application as the skilled artisan will recognize, without departing from the scope and/or spirit of the disclosure. For example, the synthetic aggregate may replace the natural sand (8) in the concrete mixture in amounts of 5%, 10%, 20%, 40%, 80% or 100% or any other amounts appropriate for the particular application. The synthetic aggregate may, for example, be made up of greater than 50% silica. Additionally, the synthetic aggregate may also include less than 20% alumna, less than 10% iron oxide, less than 2% calcium oxide, less than 5% magnesium oxide, less than 5% calcium carbonate, and less than 10% magnesium carbonate. In an alternate embodiment, however, the synthetic aggregate may include greater than 20% alumna, in addition to the components listed above. Optional ingredients that may also be added to the mixture include water or other hydrating fluid (2) and concrete admixture (7). The mixture may also include other compounds, such as coarse aggregates, sand, gravel, stone, or the like (6). The components may be mixed (4) in a suitable apparatus, such as, e.g., a concrete mixer, a continuous mixer, a ready mixed mixer, a mixing tub, or the like, or poured into a desired mold or poured directly in an intended physical location. The mixture may be allowed to harden for a predetermined period of time as is well known in the art.

The resulting product (5) may be a slab, such as, e.g., a foundation for a house, a parking lot, a roadway, a highway, a bridge, a building, or the like. The product (5) may alternatively, or additionally, be a component for constructing, e.g., a parking structure, a roadway, a highway, a parking lot, a bridge, or a building. By utilizing a synthetic aggregate in its formulation, the product (5) shows reduced warping and/or curling in comparison to existing methods and compositions.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A method for reducing at least one of curling and warping in poured concrete, the poured concrete comprising a natural fine aggregate, a natural coarse aggregate, and a bonding compound, the method comprising:
substituting a lightweight fine aggregate for at least a portion of the natural fine aggregate;
mixing the components, the mixing resulting in a mixture;
pouring the mixture, the pouring resulting in poured concrete; and
curing the poured concrete for a period of time, the curing resulting in a product.

2. The method of claim 1, wherein the lightweight fine aggregate substitutes for 5% of the natural fine aggregate.

3. The method of claim 1, wherein the lightweight fine aggregate substitutes for 10% of the natural fine aggregate.

4. The method of claim 1, wherein the lightweight fine aggregate substitutes for 20% of the natural fine aggregate.

5. The method of claim 1, wherein the lightweight fine aggregate substitutes for 40% of the natural fine aggregate.

6. The method of claim 1, wherein the lightweight fine aggregate substitutes for 80% of the natural fine aggregate.

7. The method of claim 1, wherein the lightweight fine aggregate substitutes for 100% of the natural fine aggregate.

8. The method of claim 1, wherein the poured concrete further comprises a hydrating fluid.

9. The method of claim 1, wherein the lightweight fine aggregate is at least one of synthetic aggregate, expanded clay, expanded shale, and expanded slate.

10. The method of claim 1, wherein the lightweight fine aggregate is comprised of alumna, greater than 50% silica, less than 10% iron oxide, less than 2% calcium oxide, less than 5% magnesium oxide, less than 5% calcium carbonate, and less than 10% magnesium carbonate.

11. The method of claim 10, wherein the alumna comprises less than 20% of the lightweight fine aggregate.

12. The method of claim 10, wherein the alumna comprises greater than 20% of the lightweight fine aggregate.

13. The method of claim 1, wherein the natural coarse aggregate is at least one of sand, gravel, and stone.

14. The method of claim 1, wherein the product is a component for constructing at least one of a pavement, a parking structure, a roadway, a highway, a parking lot, a bridge, and a building.

15. The method of claim 1, wherein the product is a slab for at least one of a pavement, a house, a parking lot, a roadway, a highway, a bridge, and a building.

16. The method of claim 1, wherein the poured concrete further comprises a concrete admixture.

17. A concrete component comprising:
a lightweight fine aggregate; and
a natural coarse aggregate, the lightweight fine aggregate and the natural coarse aggregate being combined in proportions to reduce at least one of warping and curling,
wherein the concrete component is configured for constructing a parking structure.

18. The component of claim 17, further comprising a natural fine aggregate, wherein the lightweight fine aggregate substitutes for 5% of the natural fine aggregate.

19. The component of claim 17, further comprising a natural fine aggregate, wherein the lightweight fine aggregate substitutes for 10% of the natural fine aggregate.

20. The component of claim 17, further comprising a natural fine aggregate, wherein the lightweight fine aggregate substitutes for 20% of the natural fine aggregate.

21. The component of claim 17, further comprising a natural fine aggregate, wherein the lightweight fine aggregate substitutes for 40% of the natural fine aggregate.

22. The component of claim 17, further comprising a natural fine aggregate, wherein the lightweight fine aggregate substitutes for 80% of the natural fine aggregate.

23. The component of claim 17, further comprising a hydrating fluid.

24. The component of claim 17, wherein the lightweight fine aggregate is at least one of synthetic aggregate, expanded clay, expanded shale, and expanded slate.

25. The component of claim 17, wherein the lightweight fine aggregate is comprised of alumna, greater than 50% silica, less than 10% iron oxide, less than 2% calcium oxide, less than 5% magnesium oxide, less than 5% calcium carbonate, and less than 10% magnesium carbonate.

26. The component of claim 25, wherein the alumna comprises less than 20% of the lightweight fine aggregate.

27. The component of claim 25, wherein the alumna comprises greater than 20% of the lightweight fine aggregate.

28. The component of claim 17, wherein the natural coarse aggregate is at least one of sand, gravel, and stone.
